(19) United States
(12) Patent Application Publication
(10) Pub. No.: US 2009/0144214 A1
(43) Pub. Date: Jun. 4, 2009

(54) Data Processing System And Method

(76) Inventors: Aditya DESARAJU, Oxford (GB); Dinesh Bhaskar Sharma, Bangalore (IN)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 12/238,337

(22) Filed: Sep. 25, 2008

(30) Foreign Application Priority Data
Dec. 4, 2007 (IN) 2879/CHE/2007

(51) Int. Cl. G06N 5/02

(52) U.S. Cl. 706/46

(57) ABSTRACT

Embodiments of the invention relate to a method of selecting events for prediction, the method comprising determining candidate events for prediction; determining, for each candidate event, a network of cause events associated with the candidate event; determining, for each cause event, a probability of occurrence in respect of the associated candidate events; and selecting candidate events for prediction based on respective confidence levels of the networks of cause events.

### BACKGROUND TO THE INVENTION

Maintenance of data processing systems in business environments to provide high availability is a challenge. The availability of applications and services on the data processing systems may be disrupted, causing events. Event monitoring products may monitor for certain events and report when these events occur.

It is an object of embodiments of the invention to at least mitigate one or more of the problems of the prior art.

### BRIEF DESCRIPTION OF THE DRAWINGS

Embodiments of the invention will now be described by way of example only, with reference to the accompanying drawings, in which:

FIG. 1 shows an example of a known event monitoring system;

FIG. 2 shows an example of a data processing system network including event monitoring;

FIG. 3 shows an example of an event monitoring system according to embodiments of the invention; and

FIG. 4 shows an example of a Bayesian Classifier Network (BCN) produced during a method according to embodiments of the invention.

### DETAILED DESCRIPTION OF EMBODIMENTS OF THE INVENTION

Embodiments of the invention predict when events may occur on a data processing system based on past behaviour of one or more data processing systems. If an event is predicted, then precautionary measures may be taken before the event actually occurs, thus avoiding at least some of the disruption caused by problems that lead to the event.

Known rule-based systems for predicting events based on past event occurrences include a rule-based approach. This comprises monitoring one or more data processing systems for certain events, and executing rules when the events occur. Such an approach can be used to predict a disruptive event by defining rules for one or more events that lead up to the disruptive event. However, such an approach is only suitable for small numbers of events as predicting large numbers of events requires an extremely complex rule system to be defined and managed.

Embodiments of the invention determine a number of candidate events for prediction. The candidate events may comprise, for example, events that have an “above normal” importance level. Events (“cause events”) that lead up to the candidate events are studied and a network is formed for each candidate event that indicates the probability of occurrence of the cause event in the past given an occurrence of the candidate event. Certain candidate events are then selected based on respective confidence levels of the networks and the probabilities of occurrence of the cause events. For example, confidence levels of the networks are determined and a predetermined number of networks with the highest confidence levels are selected. In this way, candidate events that can be predicted with high (for example, the highest) accuracy can be selected.

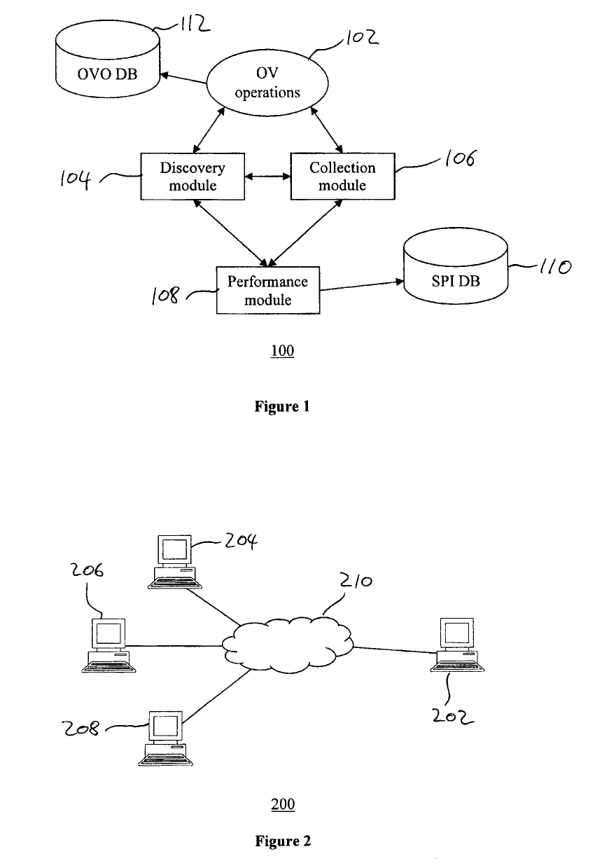

FIG. 1 shows a known system 100 for monitoring data processing systems and collecting events. The system 100 includes an OV Operations (OpenView Operations) application 102. OpenView Operations (also known as Operations Manager) is a software product from HP that can be used to monitor one or more data processing system and the applications that run on them, and to collect messages from the data processing systems. The messages collected from the data processing systems generally indicate events that have occurred. The OpenView Operations application 102 may run on one or more data processing systems and may communicate with the monitored data processing systems and/or applications over one or more wired and/or wireless networks, such as local area networks (LANs), the internet and the like.

The OV Operations application 102 includes the ability to receive Smart Plug-Ins (SPIs), which are software modules that can be added or removed as required. The system 100 includes the following SPIs: a discovery module 104, a collection module 106 and a performance module 108. The discovery module 104 can discover applications that are present on a data processing system being monitored, and configuration information of the data processing system and/or applications. The collection module 106 collects data and messages (relating to events) from monitored data processing systems, and provides performance characteristics of monitored systems to the performance module 108. The performance module 108 records the performance of monitored data processing systems and/or applications over time in a SPI metrics database (SPI DB) 110. Messages that are received by the collection module 106 relating to events can be stored in an OpenView Operations database (OVO DB) 112.

FIG. 2 shows an example of a data processing system network 200. The data processing system network 200 includes a data processing system 202 on which the OV operations application 102 and SPI modules 104, 106 and 108 are executing or may be executed, and on which the databases 110 and 112 are stored. The data processing system 202 monitors three other data processing systems 204, 206 and 208 via a network 210. For example, when an event occurs on a data processing system 204, the data processing system 204 sends a message reporting the event to the data processing system 202, on which the collections module 106 detects and processes the message.

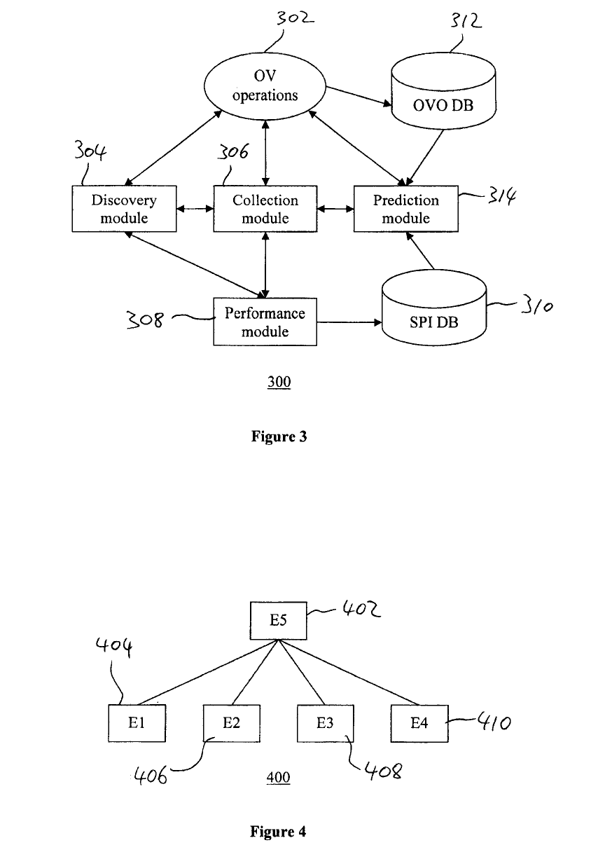

FIG. 3 shows an example of a monitoring system 300 according to embodiments of the invention that can be used within a data processing system network. The system includes an OV operations application 302, discovery module 304, collection module 306, performance module 308, SPI DB 310 and OVO DB 312. In addition, the system 300 includes a prediction module 314. The prediction module 314 monitors events that are reported to the collection module 306 and/or past events that are stored in the OVO DB 312, and uses event occurrences to predict the occurrence of future events.

For example, events may be reported that have an importance level. The importance level indicates the significance of the event. For example, a normal event is an event that is routinely reported by a data processing system (or application executing therein) and may not need further investigation. On the other hand, a critical event may require further investigation and corrective action to avoid or repair downtime within the data processing system network. The following table gives an example of event importance levels, in decreasing order of importance, and example events that may have those importance levels.

| Importance | |
|---|---|
| level | Example events |
| Critical | Service not operating, service status unavailable, |
| | application front end not operating |
| Major | Data processor utilization is high (for example, above |
| | 95%), memory utilization is high (for example, above 85%) |
| Minor | Table space utilization is above a certain level (for |
| | example, above 60%) |
| Warning | An application has logged a warning message in an |
| | application log file |
| Normal | Service is operating normally, service status is available |

The prediction module 312 selects and predicts events using methods according to embodiments of the invention. An example of such a method is described below.

The prediction module 314 selects candidate events, that is, events that are candidates for prediction at a later time, and builds a Bayesian Classifier Network (BCN) for each candidate event. A candidate event is an event that is at or above a certain importance level. In this example, a candidate event is an event that has the highest importance level (critical). Events may be those that are reported in real-time or those past events that are stored within an event history in the OVO DB 312.

A BCN is built as follows, for example. Little's law on queuing states that the average number of events N in a stable system is equal to the average arrival rate λ multiplied by the length of time T being considered, i.e.:

N=λT (1)

Therefore, a value of N or T (which has been chosen by, for example, a system administrator) yields the corresponding value for T or N. The value of λ can be determined by examining the event history, as events are recorded with their time of occurrence, or by monitoring real-time reported events. Thus, the length of time T to consider or the number of events N to consider is determined.

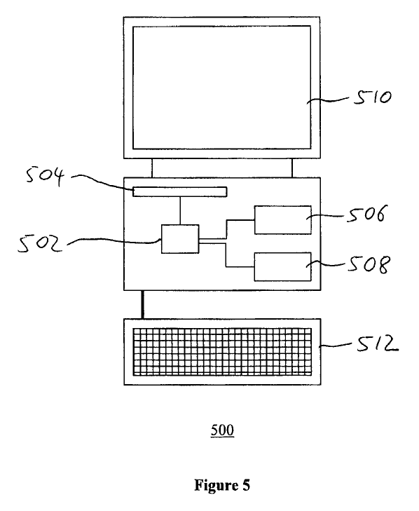

Next, the events history is scanned for events that occur at a time t±T. A candidate event (i.e. critical events) that occurs in the time period t+T becomes a root node for a BCN. Any events that occur in the time period t−T become leaf nodes for the BCN. For example, the following events may be recorded in the events history:

| Event | Time |
|---|---|
| E1 | 1:05 |
| E2 | 1:10 |
| E3 | 1:18 |
| E4 | 1:20 |
| E5 | 1:35 |

Where, for example, the time period T is 30 seconds (0:30). The time t=1:30 is being considered. The event E5 is a critical event, and occurs in the time period t+T. Thus, a BCN 400 is constructed as shown in FIG. 4 for the candidate event E5. The candidate event E5 becomes a root node 402, whereas all of the events that occurred in t−T become leaf nodes 404, 406, 408 and 410. Therefore, there are leaf nodes corresponding to the events E1, E2, E3 and E4. The leaf node events are called cause events, as these events lead up to the occurrence of the critical event E5 (although they may not necessarily be responsible or related to the critical event).

Once the nodes have been created as shown in FIG. 4, the probability of occurrence of each of the root nodes is calculated in respect of the root node E5 as follows:

$$P ( event ) = \frac{number of occurrences of the event in t - T}{total number of occurrences of the event} \qquad ( 2 )$$

The number of occurrences of the event in t−T comprises all occurrences of the event that took place in the period t−T whenever the critical event E5 took place in the period t+T, whatever the value for t. In other words, the probability P(event) of a leaf event of a BCN in respect of the critical event E5 considers multiple occurrences of the event E5. Therefore, as more events are considered in the event history and/or more real-time events are considered, the value for P(event) in respect of each leaf event in each BCN may change as more events are considered. Also, the value for P(event) for a single leaf event, such as E1 for example, may be different in different networks that have different root node critical events.

Once the BCN and probabilities are determined as indicated above for all critical events in the time period t+T, the time t being considered is advanced by T. Therefore, the events in t+T become the events in t−T, and a new set of events falls into t+T. There may be critical events in the time period t+T. If this is the case, then the event E5, which now lies in the time period t−T, becomes a leaf node for a BCN in respect of another critical event.

The time t being considered is advanced by T until no more events in the event history are available. (In embodiments where real-time events are being considered, the last 2t events are considered every t.) A number of BCNs will have been produced for all recorded past critical events, each BCN including a number of leaf nodes with associated probabilities in respect of the root node.

In the example described above, all events reported to the collection module 306 are monitored and used as leaf nodes. However, in alternative embodiments, other approaches may be used. For example, where a critical event occurs, only those events that originate from the same application and/or data processing system may be included as root nodes.

The probability of occurrence of a candidate event (critical event) C given the occurrence of all of its n leaf nodes E1, E2, . . . , En can be determined as follows:

$$P ( C \vert E 1 , E 2 , … , En ) = \frac{\begin{matrix}P ( C ) * P ( E 1 \vert C ) * \\ P ( E 2 \vert C ) * … * P ( En \vert C )\end{matrix}}{P ( E 1 ) * P ( E 2 ) * … * P ( En )} \qquad ( 3 )$$

At the start, the probability P(C), that is, the probability of the event C occurring, is assumed to be equal to all of the other critical events. That is, where n unique critical events have occurred, the probability P(C)=1/n. As critical events occur over time, the probability P(C) can be updated based on the occurrence of C.

Once the BCNs have been created for all of the candidate events (critical events), certain candidate events are selected for prediction. In other words, the prediction module 314 shown in FIG. 3 attempts to predict the selected events based on occurrence of other events. Candidate events are selected according to a confidence level of the BCN networks of which the candidate events are root nodes. For example, where confidence level for a BCN is calculated as a numerical value where a higher value indicates a higher confidence level, a predetermined number (for example, 5) of candidate events are chosen that are associated with the BCNs with the highest confidence levels.

The confidence level of each BCN may be calculated as follows. A fitness function S is calculated for a BCN B given a probability set P:

S(B|P)=ΣS(Xᵢ,pa(Xᵢ)) (4)

where
P is the set of probabilities of occurrence of the leaf nodes of the BCN B.
Xᵢ is the probability of the i-th leaf node in the BCN B.
pa (Xᵢ) is the probability of the parent node of Xᵢ, i.e. the root node of the BCN B.

S (Xᵢ, pa (Xᵢ)) is used to determine the suitability of pa (Xᵢ) to be the parent of Xᵢ. The probability of the event pa (Xᵢ) is determined by the sum of the probabilities of each of the leaf node events Xᵢ. These probabilities are calculated according to equation (3) above.

For example, consider a BCN B with a root node E3 corresponding to a critical event, and two leaf nodes E1 and E2, each with a probability of inducing E3 of 0.7 and 0.5 respectively. The fitness function S(B|P) would be:

S(B|P)=0.7+0.5=1.2

The fitness function can be normalized with respect to other root nodes. For example, where there are two further critical events E4 and E5, with fitness function values of 0.9 and 0.3 respectively, the fitness function S(B|P) can be normalized as follows:

$$S ( B \vert P ) = \frac{1.2}{1.2 + 0.9 + 0.7}$$

The fitness function for the other critical events (root nodes) can similarly be normalized. In embodiments of the invention, for example, the numerical value of the fitness function can be used to reduce the number of candidate events. For example, the candidate events chosen are those with higher (for example, the highest) fitness function values.

Once the number of candidate events has been reduced using the above criteria to a selected number of events, these events can be predicted by the prediction module 314 using rule-based systems as described above. The rule-based systems can be used in this situation as the number of events to predict has been reduced to a number where using the rule-based method is considerably less cumbersome and complicated than a system that uses the rule-based approach for all critical events. The selected events are those with the highest (for example) confidence levels and, therefore, these events may be the events that can be most reliably predicted based on other events that are observed.

In the rule based system, the direct causality of the occurring event will be evaluated for every shortlisted/selected event. The rule based methods are accurate for a small number of events (which would be the case after selecting candidate events using the fitness function). In the rule based system, the direct chances of an event occurring provided a set of events that have already occurred is registered as set of rules. Since the shortlisted BCN root nodes are few in number, the rule-based system gives a fast and accurate prediction.

Once an event has been predicted, appropriate action can be taken. For example, a person such as a system administrator may be informed that a critical event is about to occur. The system administrator may then be able to take corrective action to prevent or reduce any potential down time of data processing systems and/or applications within the data processing system network. Additionally or alternatively, one or more data processing systems in the network may include scripts or applications that can be executed or controlled in case of a predicted critical event to automatically take corrective action.

In embodiments of the invention, the Bayesian Classifier Networks (BCNs) are updated constantly as more events occur and are reported in real time. The confidence level of the BCNs can also change over time. Where confidence levels change, a new set of selected candidate events (root nodes of the BCNs) can be selected and used in the rule-based prediction system. Where the confidence level for a BCN falls below (for example) a predetermined threshold level, then the BCN can be discarded. New BCNs can be created if new events are reported with an importance level at or above a certain level (for example, critical events).

FIG. 5 shows an example of a data processing system 500 suitable for use with embodiments of the invention. The data processing system 500 includes a data processor 502 and main memory 504. The system 500 may also include a permanent storage device 506 (such as a hard disk) and/or a communications device 508 that enables the system to communicate with, for example, other data processing systems via a network. The data processing system 500 may also include a display device 510 and/or a human interface device 512 (such as a mouse and/or keyboard).

It will be appreciated that embodiments of the present invention can be realised in the form of hardware, software or a combination of hardware and software. Any such software may be stored in the form of volatile or non-volatile storage such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape. It will be appreciated that the storage devices and storage media are embodiments of machine-readable storage that are suitable for storing a program or programs that, when executed, implement embodiments of the present invention. Accordingly, embodiments provide a program comprising code for implementing a system or method as claimed in any preceding claim and a machine readable storage storing such a program. Still further, embodiments of the present invention may be conveyed electronically via any medium such as a communication signal carried over a wired or wireless connection and embodiments suitably encompass the same.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed. The claims should not be construed to cover merely the foregoing embodiments, but also any embodiments which fall within the scope of the claims.

1. A method of selecting events for prediction, the method comprising:
determining candidate events for prediction;
determining, for each candidate event, a network of cause events associated with the candidate event;
determining, for each cause event, a probability of occurrence in respect of the associated candidate events; and
selecting candidate events for prediction based on respective confidence levels of the networks of cause events.

2. A method as claimed in claim 1, comprising monitoring events to predict the selected candidate events.

3. A method as claimed in claim 1, comprising monitoring the events using a rule-based system.

4. A method as claimed in claim 1, wherein determining a network of cause events associated with a candidate event comprises determining events that occur during a first time period before the candidate event.

5. A method as claimed in claim 4, wherein determining the probability of occurrence for a cause event comprises calculating the number of occurrences of the cause event during first time periods before the associated candidate event divided by the total number of event occurrences in the first time periods.

6. A system for selecting events for prediction, the system arranged to:
determine candidate events for prediction;
determine, for each candidate event, a network of cause events associated with the candidate event;
determine, for each cause event, a probability of occurrence in respect of the associated candidate events; and
select candidate events for prediction based on respective confidence levels of the networks of cause events.

7. A system as claimed in claim 6, arranged to monitor events to predict the selected candidate events.

8. A system as claimed in claim 6, arranged to monitor the events using a rule-based system.

9. A system as claimed in claim 6, arranged to determine a network of cause events associated with a candidate event by determining events that occur during a first time period before the candidate event.

10. A system as claimed in claim 9, arranged to determine the probability of occurrence for a cause event by calculating the number of occurrences of the cause event during first time periods before the associated candidate event divided by the total number of event occurrences in the first time periods.

11. A computer program comprising instructions for implementing one of a method as claimed in claim 1 and a system as claimed in claim 6.

12. A data processing system arranged to implement one of a method as claimed in claim 1 and a system as claimed in claim 6.
